(19) United States
(12) Patent Application Publication
(10) Pub. No.: US 2021/0014046 A1
(43) Pub. Date: Jan. 14, 2021

(54) ASSURED LEDGER OF RECORDS

(71) Applicant: Insolar Technologies GmbH, Zug (CH)

(72) Inventors: Kirill Ivkushkin, Moscow (RU); Vladimir Stepanov, Moscow (RU); Pavel Kirillov, Moscow (RU); Andrei Zhulin, Moscow (RU); Petr Fedchenkov, Moscow (RU); Dmitrii Zhulin, Moscow (RU)

(21) Appl. No.: 16/507,665

(22) Filed: Jul. 10, 2019

(51) Int. Cl. H04L 9/08; G06F 16/182

(52) U.S. Cl. CPC H04L 9/088; G06F 16/182

(57) ABSTRACT

Systems and methods for storing records and data in a distributed ledger or blockchain are provided. In an extended form of a ledger or blockchain, referred to as an assured ledger, one or more records may have a reference to a previous record and a reference to a reason record that represents an operation that caused creation of the record itself. The assured ledger technology tracks causation as a chain of reasons why the ledger was updated and a change was made to a certain object that is represented on the distributed ledger, such as a smart contract.

### FIELD OF TECHNOLOGY

The present disclosure relates generally to the field of blockchain technology, more specifically, to systems and methods for storing an assured distributed ledger of records.

### BACKGROUND

Blockchain technology is an emerging technology for decentralized digital recordkeeping and is being used in a growing number of businesses and industries. The blockchain is a data structure that stores a list of transactions and can be thought of as a distributed electronic ledger that records transactions between a source and a destination, or a sender and a recipient. The transactions are batched together into blocks and every block refers back to or is linked to a prior block in the chain. Computer nodes, sometimes referred to as miners, maintain the blockchain and cryptographically validate each new block (and the transactions contained therein) using a proof-of-work system or other schemes.

### SUMMARY

Thus, a system and method is disclosed herein storing a distributed ledger of records, and, more particularly, for storing a distributed ledger of records comprised of records that reference other records that represent operations that caused changes to objects stored in the distributed ledger.

According to an exemplary aspect of the present disclosure, a method for storing a distributed ledger of records is provided. The method includes receiving, by an executor node, an invocation request to change an object stored in a first record in a distributed ledger maintained by a blockchain network of nodes. The invocation request is stored in a second record in the distributed ledger. The method further includes retrieving the object from the first record and invoking functionality of the smart-contract module. The object includes a smart-contract module having computer-executable instructions configured to perform functionality that changes a state of the object. The method further includes generating a third record that stores a modified state of the object and contains a first reference to the second record representing a reason of the change to the object and a second reference to the first record representing a previous state of the object.

In another aspect, the method further includes validating the invocation request.

In another aspect, the method further includes retrieving contents of the request from the second record, wherein the second record contains the request and defines which object is to be changed by the request.

In another aspect, the method further includes checking the integrity of the object based on whether the object is registered in the ledger and whether previous states of the object exist.

In another aspect, the object is a smart contract module stored in a serialized state, and wherein retrieving the object from the first record further comprises de-serializing a state of the smart contract module.

In another aspect, the third record is stored in a first block comprising a main section that references a plurality of auxiliary sections. In such an aspect, the third record may be generated according to a plurality of cryptographic schemes, wherein information for the plurality of cryptographic schemes are stored separately in the plurality of auxiliary sections.

According to another aspect, a system for storing a distributed ledger of records is provided. The system includes a memory and a hardware processor communicatively coupled to the memory. The hardware processor is configured to receive, by an executor node, an invocation request to change an object stored in a first record in a distributed ledger maintained by a blockchain network of nodes, wherein the invocation request is stored in a second record in the distributed ledger. The processor is further configured to retrieve the object from the first record, and invoke functionality of the smart-contract module. The object may include a smart-contract module having computer-executable instructions configured to perform functionality that changes a state of the object. The processor is configured to generate a third record that stores a modified state of the object and contains a first reference to the second record representing a reason of the change to the object and a second reference to the first record representing a previous state of the object.

According to another exemplary aspect, a computer-readable medium is provided comprising instructions that comprises computer executable instructions for performing any of the methods disclosed herein.

The above simplified summary of example aspects serves to provide a basic understanding of the present disclosure. This summary is not an extensive overview of all contemplated aspects, and is intended to neither identify key or critical elements of all aspects nor delineate the scope of any or all aspects of the present disclosure. Its sole purpose is to present one or more aspects in a simplified form as a prelude to the more detailed description of the disclosure that follows. To the accomplishment of the foregoing, the one or more aspects of the present disclosure include the features described and exemplarily pointed out in the claims.

### BRIEF DESCRIPTION OF THE DRAWINGS

The accompanying drawings, which are incorporated into and constitute a part of this specification, illustrate one or more example aspects of the present disclosure and, together with the detailed description, serve to explain their principles and implementations.

FIG. 1 is a block diagram of a system for managing and storing a distributed ledger of records, according to an exemplary aspect.

FIG. 2 is a flowchart of a method for executing a blockchain-based transaction according to an exemplary aspect.

FIG. 3 is a block diagram depicting an example assured ledger configured to track records related to supply chain and inventory management.

FIG. 4 is a block diagram illustrating a block-organized configuration of an assured ledger, according to an exemplary aspect.

FIG. 5 is a block diagram illustrating an example architecture for a blockchain network.

FIG. 6 is a block diagram of a computer system on which the disclosed system and method can be implemented according to an exemplary aspect.

### DETAILED DESCRIPTION

Exemplary aspects are described herein in the context of a system, method, and computer program product for managing and storing a distributed ledger of records. Those of ordinary skill in the art will realize that the following description is illustrative only and is not intended to be in any way limiting. Other aspects will readily suggest themselves to those skilled in the art having the benefit of this disclosure. Reference will now be made in detail to implementations of the example aspects as illustrated in the accompanying drawings. The same reference indicators will be used to the extent possible throughout the drawings and the following description to refer to the same or like items.

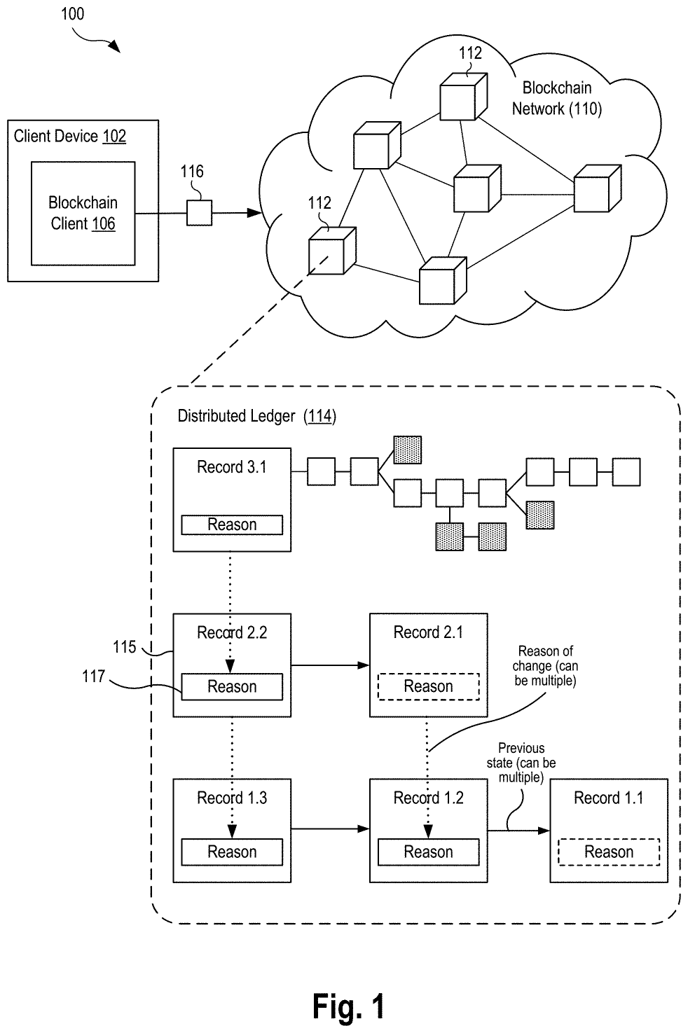

FIG. 1 is a block diagram of a system 100 for managing and storing a distributed ledger of records, according to an exemplary aspect. The system 100 may include one or more client device(s) 102 communicatively connected to and a blockchain network 110. The client device 102 may be one of personal computers, servers, laptops, tables, mobile devices, smart phones, cellular devices, portable gaming devices, media players or any other suitable devices that can retain, manipulate and transfer data. The client device 102 may include a blockchain client 106, which is a software application configured to generate and transmit one or more blockchain-based transactions or messages 116 to the blockchain network 110 for accessing or modifying records stored in the distributed ledger, such as managing user accounts, the transfer of cryptographic assets to and from such user accounts, and other types of operations.

According to an exemplary aspect, the blockchain network 110 can be a distributed peer-to-peer network formed from a plurality of nodes 112 (computing devices) that collectively maintain a distributed ledger 114, which may contain one or more blockchains 114. For purposes of present discussion, the terms distributed ledger and blockchain may be interchangeably used. The blockchain 114 is a continuously-growing list of data records hardened against tampering and revision using cryptography and is composed of data structure blocks that hold the data received from other nodes 112 or other client nodes, including the client device 102 executing an instance of the blockchain client 106. The blockchain client 106 is configured to transmit data values to the blockchain network 110 as a transaction data structure 116, and the nodes 112 in the blockchain network records and validates/confirms when and in what sequence the data transactions enter and are logged in the existing blockchain 114.

The distributed ledger may be organized into multiple blockchains 114 which are configured to ensure chronological and immutable storage of data. In one aspect, the distributed ledger may include one or more lifeline blockchains, sideline blockchains, and jet blockchains. In one implementation, lifeline blockchains are individual blockchains in which each data object and all its states are stored (i.e., objects are treated as individual blockchains). Lifeline blockchains can have logic and code associated with them, so the terms lifeline blockchain, object, and smart contract may be used interchangeably. In one aspect, sideline blockchains are utility lifeline blockchains used to store temporary or auxiliary data such as indexes, pending operations, or debug logs. A lifeline blockchain can have several associated sideline blockchains to store information. A jet blockchain may be configured to act as a shard or partition which make up storage blocks and form shard chains. Records in a jet blockchain may be first produced by a lifeline blockchain, then packaged into blocks, and placed in sequence to form a chain of blocks. Replication and distribution of data can be managed individually by blocks and jet blockchains. The use of multiple kinds of blockchains enables dynamic reconfiguration of storage by splitting and merging of jet blocks without comprising data immutability.

Distributed ledgers, e.g., having a blockchain 114, are used to store a plurality of records 115, which may contain information such as a request, a response, a control of state, and maintenance details. In known approaches to blockchain technology, records 115 of a distributed ledger are ordered chronologically by time of creation or registration, and each record of a ledger may represent an operation (or a change) made and can have a reference to a previous record which represents a baseline for the operation. The reference uniquely identifies an entity (e.g., record) and is based on or includes information (e.g., checksum, hash, or signature) to validate the integrity of the entity the reference points to. Although data stored in blockchains might track changes of the state of the object in a ledger and the entity making the change, such storage techniques fails to log the reason for the change. Often, the reason for the change is entirely absent from the blockchain or might be shallowly recorded. This results in a non-uniform approach, e.g., it may require the user to include excessive detail on certain records, or to track dependencies using third-party systems that are external to a distributed ledger or blockchain system. The drawback to known approach to blockchain technology arise in scenarios in which an investigation, claims, or reporting takes place with respect to the validity of ledger changes. Such investigations can become more costly as time goes by due to the amount of blockchain operations that must be investigated and the reasons as to why such operations were conducted (on the records of the ledger). Moreover, many organizations might not have the resource capacity to carry out such a resource-intensive investigation.

In some aspects, each record 115 may contain data objects, such as smart-contract modules. Smart contract module are software module comprised of computer-executable instructions or code that is run by one of the nodes 112 of the blockchain network when triggered by certain messages or transactions from other nodes or clients (e.g., blockchain clients 106). The smart-contract modules contain functionality that may be accessed (via blockchain transactions) to modify a state of the object. As used herein, the term functionality may be computer-executable code configured to perform one or more specific tasks or operations, and which may be organized within a single computing subroutine (e.g., function, method, procedure), distributed across multiple subroutines, distributed across multiple objects, or some combination thereof. When deployed to the blockchain 114, a smart contract module may be allocated a unique contract address associated with the smart contract. For example, the contract address of the smart contract module may be formatted similarly to a hash of a public encryption key but does not have any mathematical relation to a corresponding private key (as a public key has). The contract address associated with the smart contract can be used to trigger the functionality provided by the smart contract. For example, the blockchain client 106 may send a blockchain transaction to the blockchain network having a recipient address field specifying the smart contract module and a payload specifying that the particular functionality is to be triggered. In another example, there may be other smart contract modules that are each deployed to the blockchain 114, and that interact with each other by calling or sending digital messages via the blockchain. That is, the smart-contract module's functionality may be triggered by an invocation request from another smart-contract module, for example, using smart-contract messaging.

Aspects of the present disclosure provide an extended form of a distributed ledger referred to herein as an “assured” ledger that tracks causality as the chain of reasons why the ledger was updated and a change was made to a certain object that is represented on the ledger. Accordingly, the assured ledger system strengthens blockchain technology and its application in business processes by allowing a full history and causation of actions to be maintained, together with the reasons why data within the ledger has been updated. This is particularly useful, for example, in contracting, since the origins of all operations can be traced for legal purposes, and the integrity of the reasons is guaranteed (assured).

According to an aspect, the blockchain 114 is configured such that a record 115 contained in the blockchain contains a reference to a previous record and a reference 117 to a record (i.e., a “reason record”) that represents another operation that caused creation of the record from the previous record. For instance, in the example portion of the blockchain 114 shown in FIG. 1, the record 1.2 contains a first reference to a previous record 1.1 (record 1.1 representing the previous state of record 1.2) and a second reference to a reason record 2.1 that represents an operation that caused creation of record 1.2 from record 1.1. In some aspects, the reference to a previous record can be omitted when the record introduces a new entity or element into a ledger. It is understood that the record 2.1 and records 1.1 and 1.2 may live in completely separate blockchains and/or different types of blockchains. That is, a reason record (record 2.1) may be stored in a separate blockchain and/or type of blockchain as the records representing current and previous states of an object (records 1.1 and 1.2). In some aspects, a data object and all its states are stored in a blockchain of records (e.g., records 1.1, 1.2, and 1.3).

In one aspect, each record 115 may include information about which nodes/servers have performed the operation described by the record, and may include a proof (or a reference to a record with such proof) that node(s) had rights or were entitled to perform the operation with to create or register the record. In some aspects, such information may include binding digital signatures of which node did what action and indications of why the action was permitted.

As described in greater detail below, an executor node in the blockchain network may receive a request (a reason to make a change) from another node. The executor node may validate the request (a reason), i.e., whether the request is registered in the ledger, whether previous states of the request exists, etc. The executor node reads the content of the request (reason) and defines which object should be changed. The execute checks the integrity of the object, i.e., whether the object is registered in the ledger, whether previous states of the object exists, etc. The executor node then carries out the requested operation and forms a new record with references to the reason of change and to the baseline (i.e., previous state) of the object.

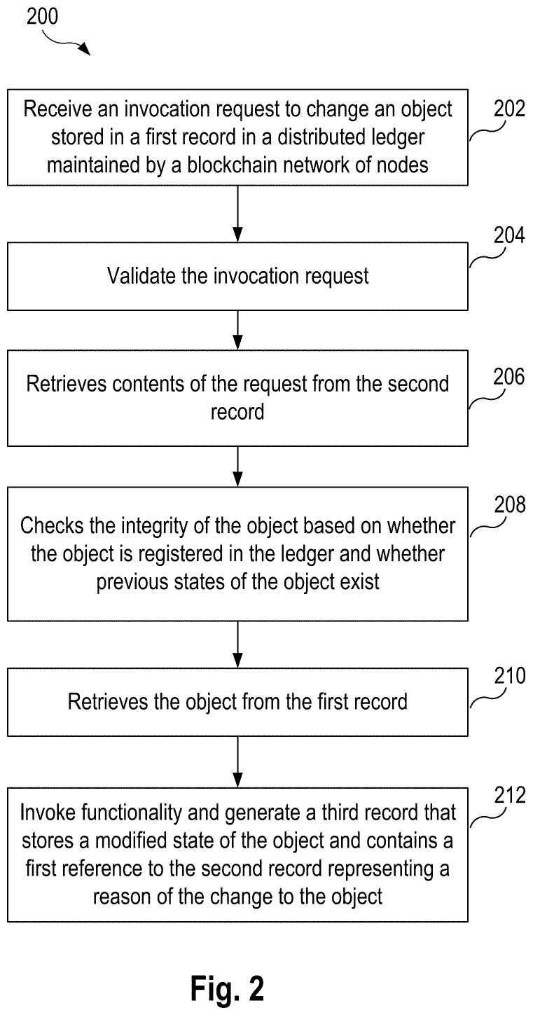

FIG. 2 is a flowchart of a method 200 for executing a blockchain-based transaction according to an exemplary aspect. It is noted that the following description of the exemplary method makes reference to the system and components described above.

The method 200 begins at step 202, in which receiving an invocation request to change an object stored in a first record in a distributed ledger maintained by a blockchain network of nodes. The action 202 may be performed by one of the nodes 112 within the blockchain network 110 having an assigned executor role. In some aspects, the object may be a smart-contract module having computer-executable instructions configured to perform functionality that changes a state of the object.

At step 204, the executor node may validate the invocation request. For example, a node in the blockchain network may check if the request was already registered but not yet completed (e.g., pending status), stores the request in the ledger such as in a second record and gives registration proof of the request.

At step 206, the executor node retrieves contents of the request from the second record. In some aspects, the second record may contain the request and defines which object is to be changed by the request. For example, the second record may contain an invocation request (i.e., “A.fn(y)”) to execute functionality of an object A stored in the first record.

At step 208, the executor node checks the integrity of the object based on whether the object is registered in the ledger and whether previous states of the object exist. In some aspects, the integrity check may include cryptographic validation and/or use of a contract address associated with the smart-contract module stored in the first record.

At step 210, the executor node retrieves the object from the first record. In some aspects, the executor node may retrieve a state of the object (e.g., smart-contract module) from another node (e.g., light material node) and load the instance of the object into a virtual machine. For example, the executor node may retrieve a state of the object stored in a serialized state, de-serialize the object data, and load the object for use. The smart contract module, executing on a node of the blockchain network, includes an internal data store that is used to maintain state of the smart contract, in this instance, of state information related to the data object.

At step 212, the executor node may invoke functionality of the smart-contract modules specified by the invocation request, which modifies the state of the object. For example, the executor node carries out the requested operation (e.g., “fn(y)”). The executor node may generate a third record that stores a modified state of the object. The third record contains a first reference to the second record representing a reason of the change to the object and a second reference to the first record representing a previous state of the object. In some aspects, the reference to the record representing a reason of the change to the object (reason record) may be based on a cryptographic value derived from an address or identifier associated with the reason record (e.g., hash value). In one aspect, the reference to the record representing the reason of the change to the object may include one or more identifiers. For example, the reference to the record may include (i) an identifier of a block (e.g., sequence or time-based identifier), and (b) an identifier of a record inside of that block (e.g., hash-based identifier, or similar). Other implementation options are possible for representing a reference to the reason of the change to an object, such as a block being identified by its hash, etc.

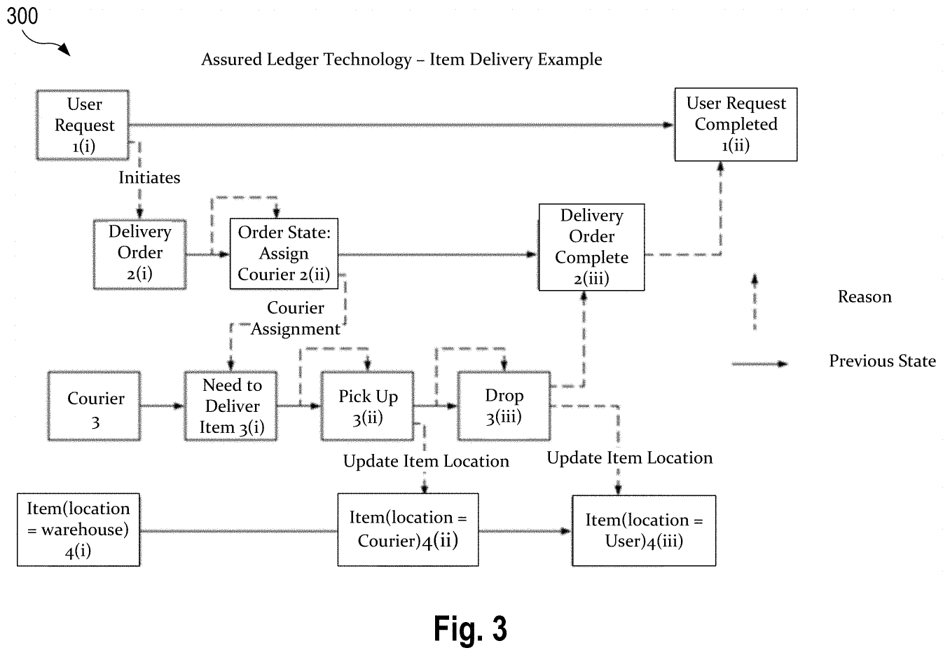

FIG. 3 is a block diagram depicting an example assured ledger 300 configured to track records related to supply chain and inventory management. In one implementation, the assured ledger 300 may include a plurality of records used to track the delivery of an item from a warehouse to a user. It is understood that the reasons for business transactions can be multi-faceted. When an end-user makes a decision to complete a transaction, this sets off a chain of actions, each with its own reason. The assured ledger technology enables the tracing of the chain of reasons of all operations conducted and ensures the integrity of these reasons (e.g., via cryptographic means). Compared to conventional blockchain technology, assured ledger technology adds a multi-tiered reason proof for each action, which is particularly useful in business settings because businesses often work on a multi-level hierarchy. In item delivery example in FIG. 3, four levels were shown: User, Delivery Order, Courier, and Item. The described assured ledger system reduces the cost of legal investigations or reporting as the reasons for each operation are recorded. Business operations imply a multi-tier separation of concerns in a multi-actor environment. This means there is a necessity to trace why an operation (based on a single user request) should take place at every step of its execution.

In the example shown in FIG. 3, the records may include a plurality of levels, including a first level associated with users, a second level for shops (delivery order), a third level for couriers, and a fourth level for items. In one aspect, each level of objects (e.g., user, delivery order, courier, item) may be stored in separate blockchains, e.g., separate lifeline blockchains. Table 1 below provides example states of various objects (e.g., user, delivery, courier, item) and reasons for changes to those states which are recorded within the assured ledger.

TABLE 1

| Level | Action/Object State | Reason |
|---|---|---|
| 1. User | i. The user makes a request for an | External request, received from |
| | item delivery. | the user. [Record 1(i)] |
| | ii. The user receives their order | Delivery order is complete. |
| | and the request is satisfied. | [Record 2(iii)] |
| 2. Delivery | i. The request initiates a delivery | The user made a request for an |
| | order. | item delivery. [Record 1(i)] |
| | ii. The delivery order changes | To deliver the item to the user. |
| | state to assign a courier. | [Record 2(i)] |
| | iii. The delivery order is completed. | [Record 3 (iii)] |
| 3. Courier | i. The courier is assigned the order. | The shop changes the order state |
| | | to assign a courier. [Record 2(ii)] |
| | ii. The courier collects or picks up | To deliver the item as per user |
| | the order. | request. [Record 3(i)] |
| | iii. The courier drops off the order. | To deliver the item and complete |
| | | the order. [Record 3(ii)] |
| | iv. The delivery order is completed. | Delivery order is complete. |
| | | [Record 3(iii)] |
| 4. Item | i. The item resides at the warehouse. | Purchased with the purpose |
| | | of resale. |
| | ii. The item is moved to the courier | An order for the item has been |
| | collection point and collected by the | placed. [Record 3(ii)] |
| | courier. | |
| | iii. The item is delivered to the user. | To complete the user request. |
| | | [Record 3(iii) |

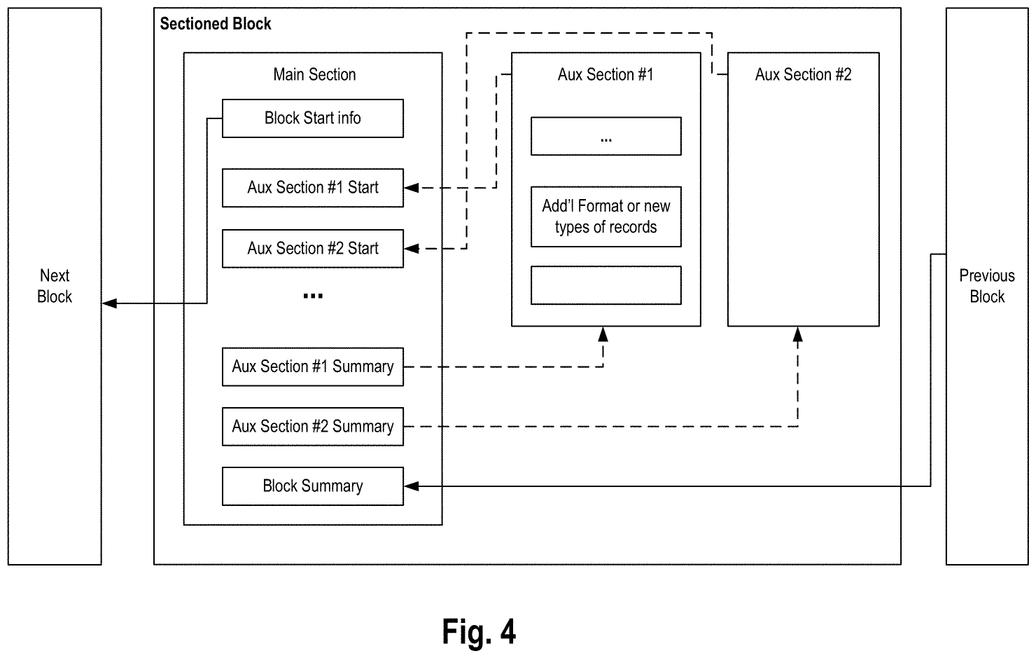

FIG. 4 is a block diagram illustrating a block-organized configuration of an assured ledger, according to an exemplary aspect. In a block-organized configuration, the assured ledger organizes its records into a plurality of blocks. Each block may contain one or more references to blocks preceding this block logically or chronologically. In some aspects, each block further includes information about which nodes/servers have created/composed the block, and may include a proof that the node(s) were authorized to perform the operation and to create or register certain records (e.g., Record 1.1 shown in FIG. 1).

According to aspects, the assured ledger may utilize an extended form of the block-organized assured ledger, referred to herein as a sectioned assured ledger. As shown, each block may be extended to have both a main section and one or more auxiliary section. The main section may be considered an equivalent of the general block-organized assured ledger, where additional records (section-management records) carry information about the auxiliary section(s) considered as a part of this block. The auxiliary section(s) comprise a set of additional records that can either be included into the block, or stored aside as an additional data structure. In the example shown in FIG. 4, the main section may contain one or more references to the start of each auxiliary section (i.e., “Aux Section #1 start”, “Aux Section #2 start”). The main section may further include one or more summary values corresponding to each of the auxiliary section(s).

According to an aspect, the sectioned assured ledger may be configured to support multiple cryptographic schemes within the ledger (i.e., Multi-Cryptography Assured Ledger). The sectioned assured ledger may be a precursor to the Multi-Cryptography Assured Ledger facilitating Extendable Blockchain Cryptography, which additionally enables the use of multiple cryptographic proofs/signatures per record, thereby improving the use of reason records (and all other kinds) in terms of differences between legal and corporate regulations of parties (so multiple different types of signatures can be applied, etc.) In one aspect, the multi-cryptography assured ledger having a record (A) that falls under the requirements of multiple cryptography schemes may further include auxiliary cryptography records in the relevant auxiliary section(s). These auxiliary cryptography records carry cryptography-related information (digests, hashes, signatures etc.) that complement the main record (A) and were generated in accordance with applicable cryptography schemes. For example, a first auxiliary section may store cryptography-related information (e.g., r, s values) for verifying Record A using elliptic-curve cryptography scheme, and a second auxiliary section may store cryptography-related information for verifying Record A using a different cryptographic scheme (e.g., RSA algorithm). To ensure that the integrity of data is established completely under a first cryptographic scheme (e.g., CS1), if there is a first block (B1) that precedes block (B2) then a CS1 auxiliary section for a second block B2 can include a record that contains CS1-based integrity information about CS1 auxiliary section of the first block B1.

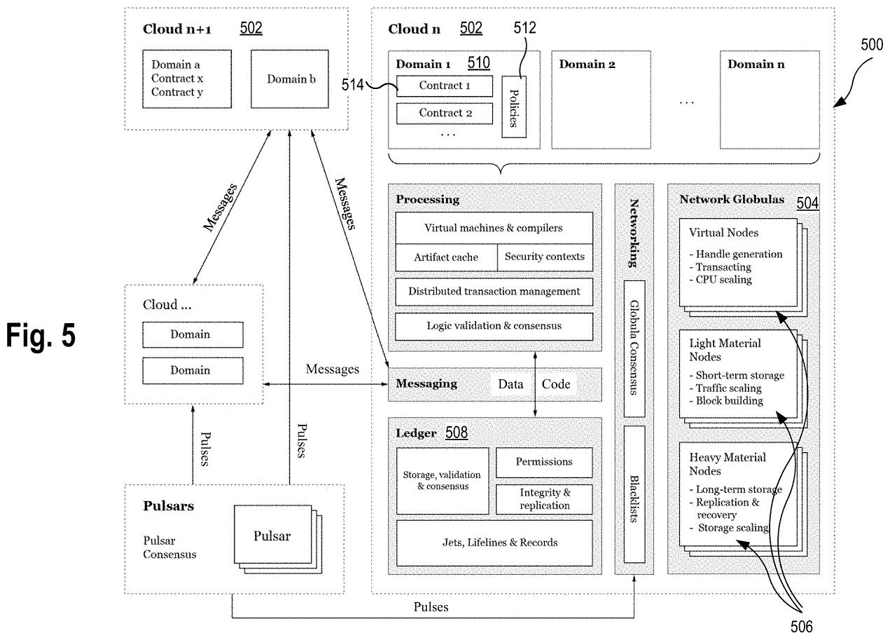

FIG. 5 is a block diagram illustrating an example architecture for a blockchain network of nodes. An example system 500 according to the depicted architecture shown in FIG. 5 can be configured to provide the blockchain network (110) of nodes suitable for managing the distributed ledger 114 and implementing assured ledger technology and associated techniques described herein.

The system 500 comprises a plurality of component and subcomponents that supports execution of a federation of clouds 502 (e.g., Cloud n, Cloud n+1), where each cloud 502 is run and governed independently (e.g., by a community, company, industry consortia, or national agency). In one aspect, each cloud 502 may be comprised of a blockchain network under a same node membership policy. Each cloud 502 organizes and unifies software capabilities, hardware capacities, and financial and legal liability of nodes to ensure transparent and seamless operation of business services. Each cloud 502 may include a globular network 504 having a plurality of nodes 506 (i.e., computing instances or servers that provide hardware capacity to a cloud). The globular network 504 may act as a backbone of a cloud, using a set of protocols enabling the coordination of networks of multitudes of nodes (e.g., 1,000's of nodes), including P2P networks and hierarchical nodes. In one aspect, the globular network 504 may be configured to run as a decentralized network with consistency between the nodes managed by a leaderless, byzantine fault tolerant (BFT)-based consensus mechanism. In some aspects, the system 500 may include larger node networks of multiple globular networks (e.g., 100 globulas each having 1,000 nodes for a total of 100,000 nodes) that behave transparently across such networks in accordance with whichever contract logic is in place, and that rely on an inter-globula network protocol with leader-based consensus.

In one aspect, each of the plurality of nodes 506 may be configured using a multi-role model: each node has a single static role (e.g., virtual, light material, heavy material, neutral) that defines its primary purpose and a set of dynamically assigned roles within the system 500. For example, a node having a virtual role performs calculations; a node having a light material role performs short-term data storage and network trafficking; a node having a heavy material role performs long-term data storage; and a node having a neutral role participates in the network consensus (not in the workload distribution) and has at least one utility role.

In one aspect, a cloud 502 may include one or more domains 510 which is a decentralized application that governs access to consensus, mutability, and other capabilities for other decentralized applications. The use of multiple domains (e.g., Domain 1, Domain 2, . . . Domain n) enables different governance models, and can be used to define policies 512 for data and (smart) contracts 514, such as policies that allow public or permissioned models, or to apply national or industry standards. In one aspect, domains 510 establish governance of contracts and nodes, thus acting as a super contract that can contain objects and their history and can apply varying policies to the objects contained therein.

In one aspect, the cloud 502 may be configured to store a distributed ledger 508 of data and records that are distributed across a network of nodes 506 that store data. In one aspect, data is stored in the ledger 508 as a series of immutable records. Records may be created and signed by virtual nodes. Each record may be addressed by its hash and a pulse number. Records can contain a reference to another record, thus, creating a chain. A record can contain a reference to another record (e.g., a reason record) in a same blockchain or in a different blockchain. An example of a chain is the object's lifeline. Each material node may be responsible for its own lifelines determined by their hashes.

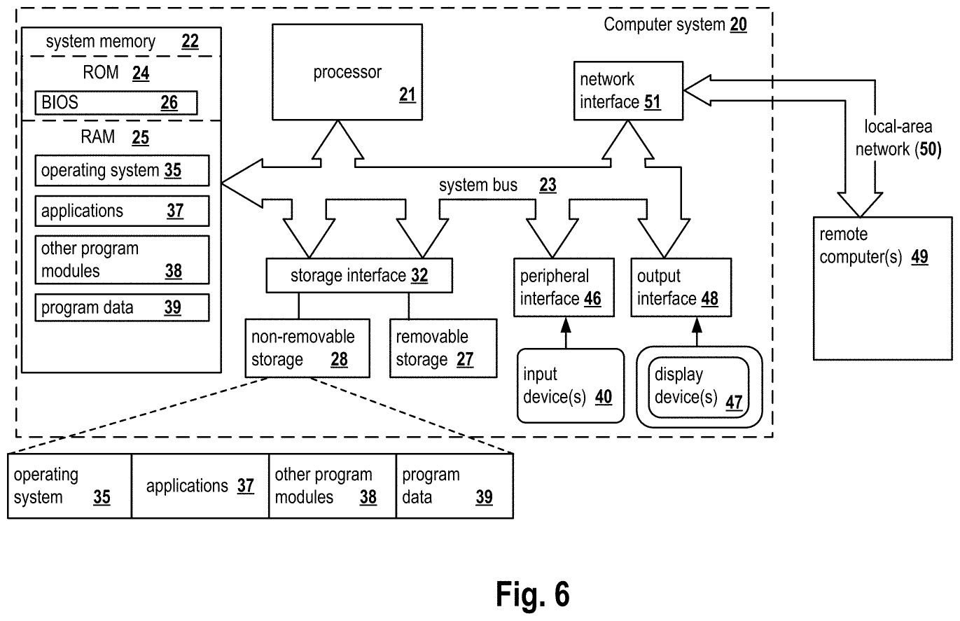

FIG. 6 is a block diagram illustrating a computer system 20 on which aspects of systems and methods for executing a blockchain-based transaction for transferring ownership of a user account to a third-party organization may be implemented in accordance with an exemplary aspect. It should be noted that the computer system 20 could correspond to the client device 102, for example, described earlier. The computer system 20 can be in the form of multiple computing devices, or in the form of a single computing device, for example, a desktop computer, a notebook computer, a laptop computer, a mobile computing device, a smart phone, a tablet computer, a server, a mainframe, an embedded device, and other forms of computing devices.

As shown, the computer system 20 includes a central processing unit (CPU) 21, a system memory 22, and a system bus 23 connecting the various system components, including the memory associated with the central processing unit 21. The system bus 23 may comprise a bus memory or bus memory controller, a peripheral bus, and a local bus that is able to interact with any other bus architecture. Examples of the buses may include PCI, ISA, PCI-Express, Hyper Transport™, InfiniBand™, Serial ATA, I²C, and other suitable interconnects. The central processing unit 21 (also referred to as a processor) can include a single or multiple sets of processors having single or multiple cores. The processor 21 may execute one or more computer-executable code implementing the techniques of the present disclosure. The system memory 22 may be any memory for storing data used herein and/or computer programs that are executable by the processor 21. The system memory 22 may include volatile memory such as a random access memory (RAM) 25 and non-volatile memory such as a read only memory (ROM) 24, flash memory, etc., or any combination thereof. The basic input/output system (BIOS) 26 may store the basic procedures for transfer of information between elements of the computer system 20, such as those at the time of loading the operating system with the use of the ROM 24.

The computer system 20 may include one or more storage devices such as one or more removable storage devices 27, one or more non-removable storage devices 28, or a combination thereof. The one or more removable storage devices 27 and non-removable storage devices 28 are connected to the system bus 23 via a storage interface 32. In an aspect, the storage devices and the corresponding computer-readable storage media are power-independent modules for the storage of computer instructions, data structures, program modules, and other data of the computer system 20. The system memory 22, removable storage devices 27, and non-removable storage devices 28 may use a variety of computer-readable storage media. Examples of computer-readable storage media include machine memory such as cache, static random access memory (SRAM), dynamic random access memory (DRAM), zero capacitor RAM, twin transistor RAM, enhanced dynamic random access memory (eDRAM), extended data output random access memory (EDO RAM), double data rate random access memory (DDR RAM), electrically erasable programmable read-only memory (EEPROM), NRAM, resistive random access memory (RRAM), silicon-oxide-nitride-silicon (SONOS) based memory, phase-change random access memory (PRAM); flash memory or other memory technology such as in solid state drives (SSDs) or flash drives; magnetic cassettes, magnetic tape, and magnetic disk storage such as in hard disk drives or floppy disks; optical storage such as in compact disks (CD-ROM) or digital versatile disks (DVDs); and any other medium which may be used to store the desired data and which can be accessed by the computer system 20.

The system memory 22, removable storage devices 27, and non-removable storage devices 28 of the computer system 20 may be used to store an operating system 35, additional program applications 37, other program modules 38, and program data 39. The computer system 20 may include a peripheral interface 46 for communicating data from input devices 40, such as a keyboard, mouse, stylus, game controller, voice input device, touch input device, or other peripheral devices, such as a printer or scanner via one or more I/O ports, such as a serial port, a parallel port, a universal serial bus (USB), or other peripheral interface. A display device 47 such as one or more monitors, projectors, or integrated display, may also be connected to the system bus 23 across an output interface 48, such as a video adapter. In addition to the display devices 47, the computer system 20 may be equipped with other peripheral output devices (not shown), such as loudspeakers and other audiovisual devices

The computer system 20 may operate in a network environment, using a network connection to one or more remote computers 49. The remote computer (or computers) 49 may be local computer workstations or servers comprising most or all of the aforementioned elements in describing the nature of a computer system 20. Other devices may also be present in the computer network, such as, but not limited to, routers, network stations, peer devices or other network nodes. The computer system 20 may include one or more network interfaces 51 or network adapters for communicating with the remote computers 49 via one or more networks such as a local-area computer network (LAN) 50, a wide-area computer network (WAN), an intranet, and the Internet. Examples of the network interface 51 may include an Ethernet interface, a Frame Relay interface, SONET interface, and wireless interfaces.

Aspects of the present disclosure may be a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store program code in the form of instructions or data structures that can be accessed by a processor of a computing device, such as the computing system 20. The computer readable storage medium may be an electronic storage device, a magnetic storage device, an optical storage device, an electromagnetic storage device, a semiconductor storage device, or any suitable combination thereof. By way of example, such computer-readable storage medium can comprise a random access memory (RAM), a read-only memory (ROM), EEPROM, a portable compact disc read-only memory (CD-ROM), a digital versatile disk (DVD), flash memory, a hard disk, a portable computer diskette, a memory stick, a floppy disk, or even a mechanically encoded device such as punch-cards or raised structures in a groove having instructions recorded thereon. As used herein, a computer readable storage medium is not to be construed as being transitory signals per se, such as radio waves or other freely propagating electromagnetic waves, electromagnetic waves propagating through a waveguide or transmission media, or electrical signals transmitted through a wire.

Computer readable program instructions described herein can be downloaded to respective computing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network interface in each computing device receives computer readable program instructions from the network and forwards the computer readable program instructions for storage in a computer readable storage medium within the respective computing device.

Computer readable program instructions for carrying out operations of the present disclosure may be assembly instructions, instruction-set-architecture (ISA) instructions, machine instructions, machine dependent instructions, microcode, firmware instructions, state-setting data, or either source code or object code written in any combination of one or more programming languages, including an object oriented programming language, and conventional procedural programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a LAN or WAN, or the connection may be made to an external computer (for example, through the Internet). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

In various aspects, the systems and methods described in the present disclosure can be addressed in terms of modules. The term “module” as used herein refers to a real-world device, component, or arrangement of components implemented using hardware, such as by an application specific integrated circuit (ASIC) or FPGA, for example, or as a combination of hardware and software, such as by a microprocessor system and a set of instructions to implement the module's functionality, which (while being executed) transform the microprocessor system into a special-purpose device. A module may also be implemented as a combination of the two, with certain functions facilitated by hardware alone, and other functions facilitated by a combination of hardware and software. In certain implementations, at least a portion, and in some cases, all, of a module may be executed on the processor of a computer system (such as the one described in greater detail in FIG. 5, above). Accordingly, each module may be realized in a variety of suitable configurations, and should not be limited to any particular implementation exemplified herein.

In the interest of clarity, not all of the routine features of the aspects are disclosed herein. It would be appreciated that in the development of any actual implementation of the present disclosure, numerous implementation-specific decisions must be made in order to achieve the developer's specific goals, and these specific goals will vary for different implementations and different developers. It is understood that such a development effort might be complex and time-consuming, but would nevertheless be a routine undertaking of engineering for those of ordinary skill in the art, having the benefit of this disclosure.

Furthermore, it is to be understood that the phraseology or terminology used herein is for the purpose of description and not of restriction, such that the terminology or phraseology of the present specification is to be interpreted by the skilled in the art in light of the teachings and guidance presented herein, in combination with the knowledge of the skilled in the relevant art(s). Moreover, it is not intended for any term in the specification or claims to be ascribed an uncommon or special meaning unless explicitly set forth as such.

The various aspects disclosed herein encompass present and future known equivalents to the known modules referred to herein by way of illustration. Moreover, while aspects and applications have been shown and described, it would be apparent to those skilled in the art having the benefit of this disclosure that many more modifications than mentioned above are possible without departing from the inventive concepts disclosed herein.

What is claimed is:

1. A method for storing a distributed ledger of records, the method comprising:
receiving, by an executor node, an invocation request to change an object stored in a first record in a distributed ledger maintained by a blockchain network of nodes, wherein the invocation request is stored in a second record in the distributed ledger;
retrieving the object from the first record, wherein the object comprises a smart-contract module having computer-executable instructions configured to perform functionality that changes a state of the object;
invoking functionality of the smart-contract module; and
generating a third record that stores a modified state of the object and contains a first reference to the second record representing a reason of the change to the object and a second reference to the first record representing a previous state of the object.

2. The method of claim 1, further comprising:
validating the invocation request.

3. The method of claim 1, further comprising:
retrieving contents of the request from the second record, wherein the second record contains the request and defines which object is to be changed by the request.

4. The method of claim 1, further comprising:
checking the integrity of the object based on whether the object is registered in the ledger and whether previous states of the object exist.

5. The method of claim 1, wherein the object is a smart contract module stored in a serialized state, and wherein retrieving the object from the first record further comprises de-serializing a state of the smart contract module.

6. The method of claim 1, wherein the third record is stored in a first block comprising a main section that references a plurality of auxiliary sections.

7. The method of claim 6, wherein the third record is generated according to a plurality of cryptographic schemes, wherein information for the plurality of cryptographic schemes are stored separately in the plurality of auxiliary sections.

8. A system for storing a distributed ledger of records, the system comprising:
a memory; and
a hardware processor communicatively coupled to the memory and configured to:
receive, by an executor node, an invocation request to change an object stored in a first record in a distributed ledger maintained by a blockchain network of nodes, wherein the invocation request is stored in a second record in the distributed ledger;
retrieve the object from the first record, wherein the object comprises a smart-contract module having computer-executable instructions configured to perform functionality that changes a state of the object;
invoke functionality of the smart-contract module; and
generate a third record that stores a modified state of the object and contains a first reference to the second record representing a reason of the change to the object and a second reference to the first record representing a previous state of the object.

9. The system of claim 8, wherein the processor is further configured to:
validate the invocation request.

10. The system of claim 8, wherein the processor is further configured to:
retrieve contents of the request from the second record, wherein the second record contains the request and defines which object is to be changed by the request.

11. The system of claim 8, wherein the processor is further configured to:
check the integrity of the object based on whether the object is registered in the ledger and whether previous states of the object exist.

12. The system of claim 8, wherein the object is a smart contract module stored in a serialized state, and wherein retrieving the object from the first record further comprises de-serializing a state of the smart contract module.

13. The system of claim 8, wherein the third record is stored in a first block comprising a main section that references a plurality of auxiliary sections.

14. The system of claim 13, wherein the third record is generated according to a plurality of cryptographic schemes, wherein information for the plurality of cryptographic schemes are stored separately in the plurality of auxiliary sections.

15. A non-transitory computer readable medium comprising computer-executable instructions for storing a distributed ledger of records, including instructions for:
receiving, by an executor node, an invocation request to change an object stored in a first record in a distributed ledger maintained by a blockchain network of nodes, wherein the invocation request is stored in a second record in the distributed ledger;
retrieving the object from the first record, wherein the object comprises a smart-contract module having computer-executable instructions configured to perform functionality that changes a state of the object;
invoking functionality of the smart-contract module; and
generating a third record that stores a modified state of the object and contains a first reference to the second record representing a reason of the change to the object and a second reference to the first record representing a previous state of the object.

16. The computer readable medium of claim 15, further comprising instructions for:
validating the invocation request.

17. The computer readable medium of claim 15, further comprising instructions for:
retrieving contents of the request from the second record, wherein the second record contains the request and defines which object is to be changed by the request.

18. The computer readable medium of claim 15, further comprising instructions for:
checking the integrity of the object based on whether the object is registered in the ledger and whether previous states of the object exist.

19. The computer readable medium of claim 15, wherein the object is a smart contract module stored in a serialized state, and wherein retrieving the object from the first record further comprises de-serializing a state of the smart contract module.

20. The computer readable medium of claim 15, wherein the third record is stored in a first block comprising a main section that references a plurality of auxiliary sections, wherein the third record is generated according to a plurality of cryptographic schemes, wherein information for the plurality of cryptographic schemes are stored separately in the plurality of auxiliary sections.
